(19) United States
(12) Patent Application Publication
(10) Pub. No.: US 2021/0323575 A1
(43) Pub. Date: Oct. 21, 2021

(54) DATA ACQUISITION METHOD AND APPARATUS

(71) Applicant: BEIJING BAIDU NETCOM SCIENCE TECHNOLOGY CO., LTD., Beijing (CN)

(72) Inventors: Pengfei WEI, Beijing (CN); Houqiang ZHU, Beijing (CN); Jia SONG, Beijing (CN); Jingyuan WANG, Beijing (CN); Guiqing HAO, Beijing (CN)

(21) Appl. No.: 17/330,567

(22) Filed: May 26, 2021

(30) Foreign Application Priority Data
Dec. 18, 2020 (CN) 202011506131.9

(51) Int. Cl. B60W 60/00; G07C 5/00; G06K 9/00; G06K 9/62

(52) U.S. Cl. CPC B60W 60/0011; G06K 9/6267; G06K 9/00791; G07C 5/008

(57) ABSTRACT

The present disclosure discloses a data acquisition method and apparatus, relating to the field of autonomous driving. The specific implementation solution is: determining configuration information in response to a first input operation acting on an interface, where the configuration information includes data acquisition parameters; creating a data acquisition task in response to task creation instructions, where the configuration information in a current interface is data included in the data acquisition task; constructing and obtaining a task table according to at least one of the data acquisition tasks; and sending the task table to a vehicle terminal, where the task table is used to indicate the vehicle terminal to perform the data acquisition during a driving process of a vehicle.

### CROSS-REFERENCE TO RELATED APPLICATIONS

This application claims priority to Chinese Patent Application No. 202011506131.9, filed on Dec. 18, 2020, which is hereby incorporated by reference in its entirety.

### TECHNICAL FIELD

The present disclosure relates to the field of autonomous driving in computer technology and, in particular, to a data acquisition method and apparatus.

### BACKGROUND

Driving scene data is a core resource for autonomous driving capabilities of smart auto products such as unmanned vehicles and driving assistances. Therefore, an acquisition for the driving scene data is particularly important.

At present, when performing a driving data acquisition, the related technology configures a target scene for the data acquisition previously in general, and then inputs relevant data of the target scene into a professional data acquisition vehicle, thereby performing the data acquisition in the target scene.

### SUMMARY

The present disclosure provides a data acquisition method and apparatus, a device and a storage medium.

According to a first aspect of the present disclosure, a data acquisition method is provided, which is applied to a cloud, including:

determining configuration information in response to a first input operation acting on an interface, where the configuration information includes data acquisition parameters;

creating a data acquisition task in response to task creation instructions, where the configuration information in a current interface is data included in the data acquisition task;

constructing and obtaining a task table according to at least one of the data acquisition tasks; and

sending the task table to a vehicle terminal, where the task table is used to indicate the vehicle terminal to perform the data acquisition during a driving process of a vehicle.

According to a second aspect of the present disclosure, a data acquisition method is provided, which is applied to a vehicle terminal, including:

receiving a task table, where the task table includes at least one data acquisition task, the data acquisition task is created according to configuration information, and the configuration information includes data acquisition parameters; and

executing the at least one data acquisition task according to the task table to obtain acquired data during a driving process of a vehicle.

According to a third aspect of the present disclosure, a data acquisition apparatus is provided, which is applied to a cloud, including:

a determining module, configured to determine configuration information in response to a first input operation acting on an interface, where the configuration information includes data acquisition parameters;

a creating module, configured to create a data acquisition task in response to task creation instructions, where the configuration information in a current interface is data included in the data acquisition task;

a constructing module, configured to construct and obtain a task table according to at least one of the data acquisition tasks; and

a transceiver module, configured to send the task table to a vehicle terminal, wherein the task table is used to indicate the vehicle terminal to perform the data acquisition during a driving process of a vehicle.

According to a fourth aspect of the present disclosure, a data acquisition apparatus is provided, which is applied to a vehicle terminal, including:

a transceiver module, configured to receive a task table, where the task table includes at least one data acquisition task, the data acquisition task is created according to configuration information, and the configuration information includes data acquisition parameters; and

an executing module, configured to execute the at least one data acquisition task according to the task table to obtain acquired data during a driving process of a vehicle.

According to a fifth aspect of the present disclosure, a data acquisition system is provided, including: a cloud and a vehicle terminal, where the cloud is configured to execute the method according to the first aspect, and the vehicle terminal is configured to execute the method according to the second aspect.

According to a sixth aspect of the present disclosure, an electronic device is provided, including:

at least one processor; and

a memory communicatively connected with the at least one processor; where,

the memory stores instructions executable by the at least one processor, and the instructions are executed by the at least one processor to enable the at least one processor to execute the method according to the first aspect or the method according to the second aspect.

According to a seventh aspect of the present disclosure, a non-transitory computer-readable storage medium storing computer instructions is provided, where the computer instructions are used to enable a computer to execute the method according to the first aspect or the method according to the second aspect.

According to an eighth aspect of the present disclosure, a computer program product is provided, wherein the program product includes: a computer program, the computer program is stored in a readable storage medium, at least one processor of an electronic device can read the computer program from the readable storage medium, and the at least one processor executes the computer program to enable the electronic device to execute the method according to the first aspect or the method according to the second aspect.

It should be understood that content described in this section is not intended to identify key or important features of embodiments of the present disclosure, nor is it intended to limit a scope of the present disclosure. Other features of the present disclosure will be easily understood through the following description.

### BRIEF DESCRIPTION OF DRAWINGS

The drawings are used to better understand this solution, and do not constitute a limitation to the present disclosure. Where:

FIG. 1 is a schematic diagram of a data acquisition system provided by an embodiment of the present disclosure;

FIG. 2 is a flowchart of a data acquisition method provided by an embodiment of the present disclosure;

FIG. 3 is a second flowchart of a data acquisition method provided by an embodiment of the present disclosure;

FIG. 4 is a schematic diagram of an interface for determining configuration information provided by an embodiment of the present disclosure;

FIG. 5 is a schematic diagram of an interface for determining a task table provided by an embodiment of the present disclosure;

FIG. 6 is a schematic diagram of an interface for releasing a task table provided by an embodiment of the present disclosure;

FIG. 7 is a third flowchart of a data acquisition method provided by an embodiment of the present disclosure;

FIG. 8 is a schematic flowchart of a data acquisition method provided by an embodiment of the present disclosure;

FIG. 9 is a schematic structural diagram of a data acquisition apparatus of one embodiment of the present disclosure;

FIG. 10 is a schematic structural diagram of a data acquisition apparatus of another embodiment of the present disclosure, which is applied to a vehicle terminal; and

FIG. 11 is a block diagram of an electronic device used to implement a data acquisition method of an embodiment of the present disclosure.

### DESCRIPTION OF EMBODIMENTS

The following describes exemplary embodiments of the present disclosure in combination with drawings, which include various details of the embodiments of the present disclosure to facilitate understanding, and should be regarded as merely exemplary. Therefore, those of ordinary skilled in the art should realize that various changes and modifications can be made to the embodiments described herein without departing from a scope and spirit of the present disclosure. Likewise, for clarity and conciseness, descriptions of well-known functions and structures are omitted in the following description.

In order to better understand technical solutions of the present disclosure, a background technology involved in the present disclosure is further described in detail firstly:

an optimization training of an autonomous driving model mostly aims at scenes, thus in order to expand capability of the model, it is usually necessary to perform a data acquisition from scene by scene. Different from that a development of a baseline of the autonomous driving model which can be accomplished by collecting a large amount of data by conventional acquisition vehicles in an initial stage, in a later stage of a model iteration, the scenes will getting more focused, and the data acquisition will become more targeted. However, the clearer the scene target, the smaller the return to scale of the data acquisition, and it is costly to dispatch an acquisition vehicle for one scene to perform a full range of data acquisition tasks.

At the same time, with a gradual expansion of application fields of smart auto products, there would be more problems that to be exposed during a use process of real users; and newly generated optimization requirements for target scene models include features such as diversity, time uncertainty, severity of problems, and demands for the data is often changeable, random and urgent. Traditional data acquisition methods cannot meet research and development requirements in terms of rhythm efficiency, data quality and cost control.

In addition, there are many scenes belonging to extreme working conditions, and a specific acquisition by the acquisition vehicles has the following limitations: firstly, acquisition conditions are limited, for example, for various road driving data under heavy rain conditions, it is extremely time-consuming for acquiring amount of data required for the model optimization; secondly, acquired content is convergent, for example, for parking behavior data in narrow parking spaces, driving behaviors of drivers of certain collecting vehicles have small changes, which cannot represent driving habits of majority of users; and thirdly, it is even difficult to reproduce, for example, when a driving encounters animals, it is impossible for acquisition personals to buy or rent variety kinds of animals and place them in a wide range of real road scenes for acquisition.

The amount of the driving scene data that required to be acquired is large, and road scenes are complicated, so a large amount of scene data requires to be pre-configured, which will result in a low efficiency of the data acquisition.

The following introduces several possible implementations for collecting driving data of specific target scene for model optimization in the prior art:

(1) Selecting in open source data set or acquired data, finding the scene data that meets model training requirements, and aggregating to use.

This method is low-cost, but data selecting and filtering are particularly cumbersome. The amount and diversity of data selected from massive data sets are often difficult to meet the requirement of research and development.

(2) Arranging the acquisition vehicles to expand the collection, restoring the target scene and collecting part of the data supplementally.

This form is highly pertinent and effective in the acquired data, but a collection range is limited, and it is difficult to cover various kinds of road conditions in a short time. Although the amount of data is sufficient, a generalization ability of a trained model is weak.

(3) Outsourcing the collection to a professional collection company.

This type has a wide range of channels, has many companies that can be undertaken, and lead time is short. However, the cost is high, an applicability of the data acquired by the professional collection companies in different research and development institutions is limited, formats and an accuracy of the data are restricted by technologies and hardware of autonomous vehicle sensors in each of the companies, and there would be more or less deviations between acquired data content and the data generated by vehicles during an actual usage of the research and development institution.

It can be seen that the traditional method is difficult to achieve driving data acquisition requirements when the scene target is very clear, and the iteration of the autonomous driving model is obviously limited by the data acquisition of the scene.

As mentioned above, a traditional driving scene data acquisition method has a high comprehensive cost, the research and development institutions need to invest a lot of manpower and funds to perform acquisition tasks, and a time period for achieving the amount of data that required to meet the research and development requirements is long, which is difficult to meet project delivery and rapid iteration requirements. More importantly, the content, quality, and quantity of the acquired data are limited, and it is difficult to cover the data acquisition in a whole scene according to a single scene optimization task, thus a breadth of the acquired data is limited, which resulting in poor robustness of the trained model.

In response to the problems in the prior art, the present disclosure proposes the following technical idea: configuring the target scene and data acquisition tasks on a cloud according to actual requirements and performing the data acquisition automatically on autonomous vehicle terminals that mass-manufactured according to configured strategies by constructing a complete data link between a data cloud and a vehicle of the user, which is aims at continuously obtaining the driving scene data that actual encounters from a wide range of the users, so as to effectively ensure the breadth of the acquired data. In this process, the users can configure the target scene on the cloud by themselves, and then send the configured data to the vehicle terminal to enable the vehicle terminal to perform the data acquisition, which can effectively improve efficiency and flexibility of the data acquisition.

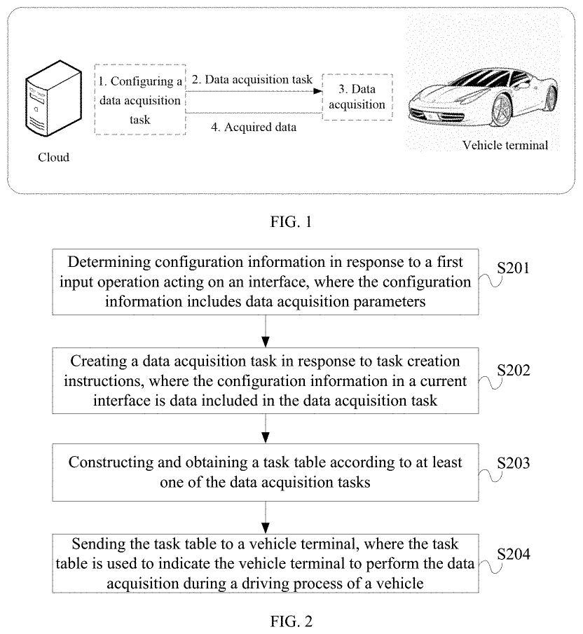

The data acquisition method provided by the present disclosure will be described below with reference to specific embodiments. A data acquisition system provided by the present disclosure will be firstly introduced with reference to FIG. 1, which is a schematic diagram of the data acquisition system provided by the embodiment of the present disclosure.

As shown in FIG. 1, the system includes: a vehicle terminal and a cloud.

Where the vehicle terminal may be, for example, a vehicle, and the vehicle may be equipped with front-facing sensor hardware such as a multi-channel camera, ultrasonic radar. Therefore, the vehicle in this embodiment has data acquisition ability, and the cloud in this embodiment can configure data acquisition tasks and issue the data acquisition tasks to the vehicle terminal, the cloud can also receive and store data acquired by the vehicle terminal.

In this embodiment, the cloud and the vehicle terminal can communicate, and specific communication modes between the cloud and the vehicle terminal can be selected according to actual requirements, as long as it can realize an interaction of data and information. In a possible implementation, the vehicle terminal in this embodiment can be understood as the vehicle, and the cloud in this embodiment can be understood as a server.

Where a data acquisition process can be shown as, for example, in FIG. 1. Refer to FIG. 1, the cloud can construct a data acquisition task, where the data acquisition task can include, for example, a data type that requires to be acquired, data acquisition conditions, an acquisition priority and a weight value and other information. A specific implementation of the data acquisition task is not specifically limited in this embodiment, and setting the data acquisition task may be determined, for example, according to an input operation of the user on the cloud.

After that, the cloud can send the data acquisition tasks to the vehicle terminal, and the vehicle terminal performs the data acquisition according to the data acquisition tasks. After the data acquisition is completed, acquired data can be sent back to the cloud, and the cloud can store the data, thereby processes such as model training and performance testing can be carried out based on the data.

Based on the above introduction, it can be determined that in the data acquisition method provided in the present disclosure, the data acquisition tasks can be flexibly configured on the cloud according to actual requirements, and the data acquisition for required data can be implemented automatically based on the data acquisition tasks issued by the cloud, which can effectively ensure efficiency and comprehensiveness of the data acquisition. The data acquisition method provided in the present disclosure will be described below in combination with specific embodiments.

FIG. 2 is a flowchart of a data acquisition method provided by an embodiment of the present disclosure. As shown in FIG. 2, the method includes:

S201, determining configuration information in response to a first input operation acting on an interface, where the configuration information includes data acquisition parameters.

In this embodiment, there may be, for example, an input device in a cloud, and the input device includes an operable interface. Users can perform input operations on the operable interface, for example, the user may perform the first input operation on the interface to input the configuration information, where the first input operation may include, for example, a control selection operation, and the first input operation may also include, for example, an information input operation.

In other words, the user can click and select on the interface, or the user can also input information on the interface to input the configuration information.

For the cloud, the cloud can determine the configuration information in response to the first input operation acting on the interface, where the configuration information includes the data acquisition parameters. For example, the configuration information can be determined based on information selected by the user and the information input by the user.

In a possible implementation, the configuration information may include, for example, at least one of the following: trigger conditions for the data acquisition, an acquisition duration, at least one piece of acquired data content, data upload times of each data content, data upload frequency of each data content and tag information.

Taking the data content as an example, there may be, for example, an input box in the interface, and the cloud may determine at least one of the data content in response to the information input by the user in the input box; or, an indication of the each data content may be preset on the cloud, and when the user is performing the first input operation, the indications of multiple data content can be displayed in a form of a drop-down list in response to a click operation of the user, and then the data content that needs to be acquired is determined according to user's selection of the indication of the data content.

The specific implementation of the first input operation of the user is not specifically limit in this embodiment, as long as the first input operation can implement a determination for the configuration information, and the specific implementation thereof can be selected according to actual requirements. Moreover, in addition to the implementation of the configuration described above, it can also be extended according to the actual requirements. It should be understood that all information used to indicate parameters of the data acquisition can be used as the configuration information in this embodiment.

S202, creating a data acquisition task in response to task creation instructions, where the configuration information in a current interface is data included in the data acquisition task.

The configuration information input by the user can be received in the interface on the cloud. Afterwards, if the cloud receives the task creation instruction, then the configuration information in the current interface is determined as the data included in the data acquisition task, thereby creating a data acquisition task.

Where the task creation instruction, for example, an “OK” control or a “Submit” control in a click interface of the user is generated in order to trigger a control of the task creation instruction.

It is understandable that one the data acquisition task can be created in one interface operation, and multiple data acquisition tasks can be created and obtained through multiple input operations and task creation instructions on the interface, where the data included in each of the data acquisition task is the data in a configuration interface corresponding to the acquisition task.

S203, constructing and obtaining a task table according to at least one of the data acquisition tasks.

After creating multiple data acquisition tasks, for example, at least one data acquisition task can be selected from the multiple data acquisition tasks to construct the task table, where a specific implementation for the data acquisition tasks can be selected according to current actual requirements of the data acquisition.

In a possible implementation, for example, the indication of each data acquisition task can be displayed in the interface, then the indication of at least one the data acquisition task is selected according to a second input operation of the user, and the task table is constructed in response to task table creating instructions.

S204, sending the task table to a vehicle terminal, where the task table is used to indicate the vehicle terminal to perform the data acquisition during a driving process of a vehicle.

After the task table is created, the cloud can send the task table to the vehicle terminal, and then after receiving the task table, the vehicle terminal performs the data acquisition according to the task table during the driving process of the vehicle.

For example, the vehicle terminal can perform the data acquisition when determining that a vehicle state satisfies the acquisition conditions during a driving process of a vehicle. A specific implementation of the data acquisition on the vehicle terminal is not limited in this embodiment, which depends on settings of the task table.

It is understandable that in the embodiment of the present disclosure, the user can customize any required data acquisition task on the operation interface on the cloud, then issue the data acquisition task to the vehicle terminal to perform the data acquisition, and in the process, the user can configure flexibly. In the implementation of the acquisition vehicle, it is usually necessary for a professional operator to configure the target scene through codes. Therefore, the solution of this embodiment can effectively improve a flexibility and simplicity when configuring the data acquisition task compared with the prior art. In addition, in the solution of the embodiment of the present disclosure, efficiency and comprehensiveness of the data acquisition can be effectively ensured by sending configured data acquisition task to the vehicle terminal and performing the data acquisition during the driving process of the vehicle.

The data acquisition method provided by the embodiment of the present disclosure includes: determining the configuration information in response to the first input operation acting on the interface, where the configuration information includes the data acquisition parameters; creating the data acquisition task in response to the task creation instruction, where the configuration information in the current interface is the data included in the data acquisition task; constructing and obtaining the task table according to at least one data acquisition task; and sending the task table to the vehicle terminal, where the task table is used to indicate the vehicle terminal to perform the data acquisition during the driving process of the vehicle. The vehicle terminal can perform the data acquisition during a real vehicle driving process by configuring the data acquisition tasks on a cloud according to actual requirements, and then sending the data acquisition tasks to the vehicle terminal, which can effectively improve comprehensiveness and efficiency of the data acquisition.

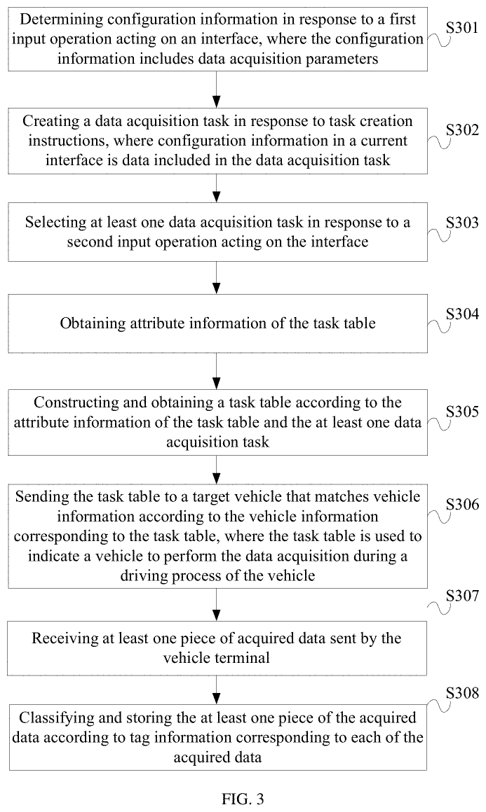

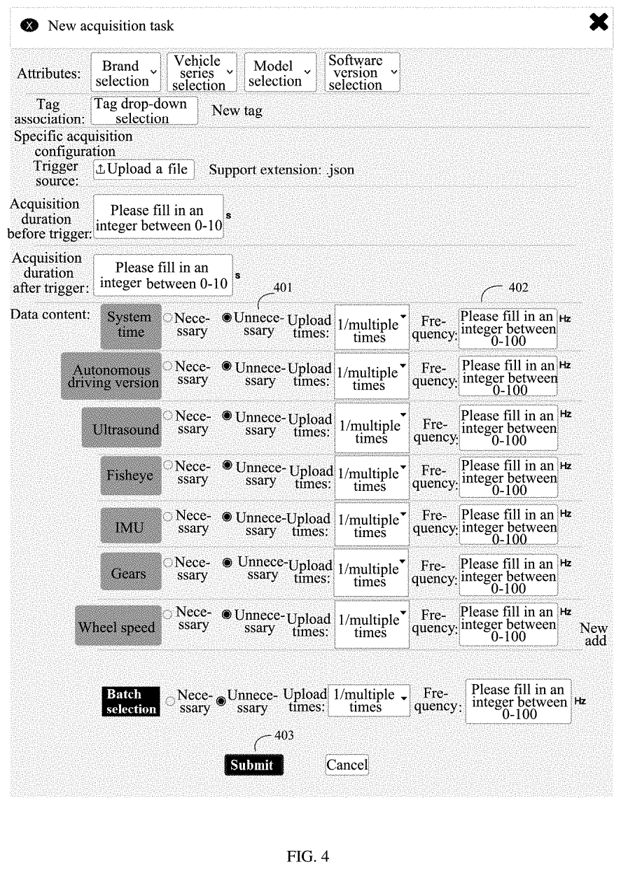

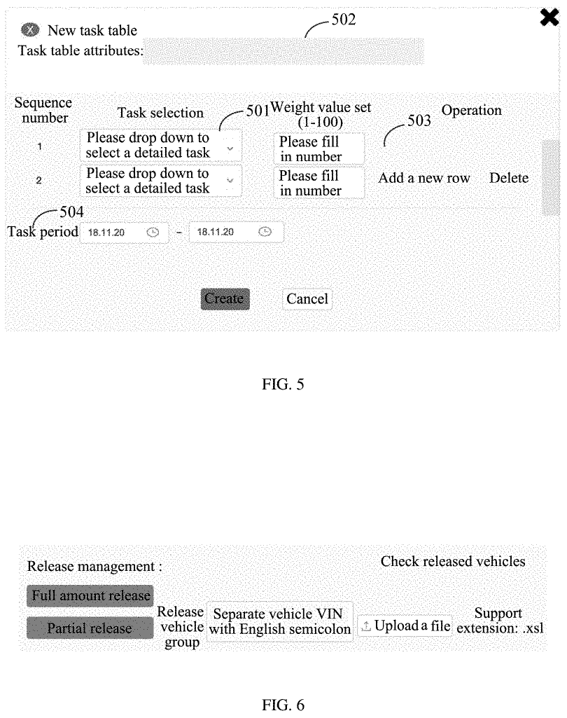

On the basis of the foregoing embodiment, the data acquisition method provided by the present disclosure will be further described in detail below in combination with specific embodiments. FIG. 3 is a second flowchart of a data acquisition method provided by the embodiment of the present disclosure, FIG. 4 is a schematic diagram of an interface for determining configuration information provided by an embodiment of the present disclosure, FIG. 5 is a schematic diagram of an interface for determining a task table provided by an embodiment of the present disclosure, and FIG. 6 is a schematic diagram of an interface for releasing a task table provided by an embodiment of the present disclosure.

As shown in FIG. 3, the method includes:

S301, determining configuration information in response to a first input operation acting on an interface, where the configuration information includes data acquisition parameters.

Where an implementation of S301 is similar to the implementation of S201, and will not be elaborated herein.

A possible implementation of determining the configuration information according to the first input operation will be introduced below in combination with FIG. 4, as shown in FIG. 4:

the first input operation may include, for example, a control selection operation as shown in 401. For example, the configuration information corresponding to 401 is acquired data content, and it is assumed that there are multiple selectable data content preset. When “System Time” needs to be selected, a necessary control corresponding to the “System Time” can be selected; and when the “System Time” does not need to be selected, an unnecessary control corresponding to the “System Time” can be selected, that is, the control shown in 401. In this embodiment, the configuration information can be input through a control selection operation.

Furthermore, the first input operation may also include, for example, an information input operation shown in 402. For example, upload frequency may be input in the input box for data content currently corresponding to the “system time”.

Therefore, in this embodiment, the cloud can determine the configuration information in response to the first input operation on the interface, where the configuration information is parameters input by the user according to actual requirements of the data acquisition.

In this embodiment, an acquisition task is a detailed description of the data acquisition that triggered by the vehicle terminal. A composition of the acquisition task may include, for example, two parts: “tag information” and “detailed description of the acquisition task”.

Where the tag information is added when each of the acquisition tasks is created, and is attached into a data format after the data acquisition, which is used for subsequent data classification management and use.

For example, one or more pre-created label items can be selected, and there can also be secondary labels, that is, after a whole task has been labelled, automatic labelling rules in specific conditions can be configured for the data items with different levels or types of trigger conditions.

For example, it can be information in a “tag association” shown in FIG. 4, tag information is used to identify a current data acquisition task for subsequent data query and storage. For example, if the current data acquisition task is the data acquisition task for rainy scenes, the tag information can be, for example, a rainy scene. In an actual implementation process, a specific implementation of the tag information can be selected according to actual requirements, which is not specifically limited in this embodiment as long as data can be identified.

Moreover, the “detailed description of the acquisition task” can refer to the various content in FIG. 4, for example, it can include the following in the target scene:

a specific trigger source: that is the trigger conditions for the data acquisition mentioned above, such as a vehicle body state, an external environment state that perceived.

Where, for a selection of the trigger source, a form of uploading configuration files is adopted for a condition configuration of a task trigger because there are various types of acquisition scenes and each scene requirement is relatively independent. A json format configuration file of a specific acquisition task is prepared in advance by a technician in a fixed format and specifications for an analysis by a platform. Configuration content includes the following: the respective trigger condition of all sub-scenes; and the relationship among conditions is represented by an OR, AND, or NON relationship.

Where the json (JavaScript Object Notation, JS object notation) is a lightweight data exchange format. In an actual implementation process, the specific format of the upload configuration file corresponding to the trigger source can be extended according to the actual requirements, as long as the file can be used to indicate specific trigger conditions.

Acquisition duration: several seconds that before and after a trigger time point can be set to collect according to data usage requirements; and

data content: in this embodiment, at least one piece of acquired data content can be selected to collect, where specific collection items can be determined according to software and hardware configuration of the mass-manufactured vehicle, and the data usage requirements, which usually include various types of sensor data, body information data, algorithm data and so forth.

It is worth noting that an IMU in the data content shown in FIG. 4 is an inertial measurement unit (Inertial Measurement Unit).

A detailed implementation of the specific data acquisition content can be selected according to the actual requirements. For example, it can be selected from preset data content, or the data content that does not exist in the current interface can also be expanded according to the actual requirements.

Upload times and upload frequency: in which, acquisition parameters of each data acquisition content can be set according to requirements, thereby determining the upload times and the upload frequency of each data content.

At the same time, vehicle terminal information to which the current data acquisition task belongs can also be selected, and a specific vehicle can be restricted from a brand-car series-a model-a version for subsequent corresponding selection in the task table.

It is worth noting that an input method for the configuration information shown in FIG. 4 is only an exemplary description, and in the actual implementation process, the implementation for inputting the specific configuration information into a page can be selected according to the actual requirements, as long as a user can configure information on the page according to the actual requirements of the data acquisition through input operations, and the specific implementation of the page is not particularly limited in this embodiment.

S302, creating a data acquisition task in response to task creation instructions, where configuration information in a current interface is data included in the data acquisition task.

After the configuration information is inputted, the configuration information input on the current interface can be determined as a data acquisition task.

In a possible implementation, the user can, for example, trigger the task creation instruction through a “confirm submission” control 403 shown in FIG. 4 to indicate that the current configuration information has been inputted and the data acquisition task needs to be created. In response to the task creation and execution, the cloud can determine the configuration information in the current interface as the information included in the data acquisition task, thereby creating the data acquisition task.

In other possible implementations, the task creation instruction may also be, for example, triggered by other operations, such as being triggered by a voice operation, and a triggering manner of the task creation instruction is not specifically limited in this embodiment.

S303, selecting at least one the data acquisition task in response to a second input operation acting on the interface.

In this embodiment, after the creation of the data acquisition task is completed, the cloud can uniformly manage multiple scene data acquisition tasks in a form of a task table, where the task table is a carrier for the cloud to issue tasks to the vehicle terminal, which includes the data acquisition tasks in all scenes that need to be performed on a single vehicle.

The task table cam include at least one data acquisition task, and based on the above description, it can be determined that at least one the data acquisition task has been configured currently. In this embodiment, for example, at least one the data acquisition task included in the task table can be selected in respond to the second input operation acting on the interface.

For example, refer to FIG. 5. In FIG. 5, in task selection options, multiple data acquisition tasks that have been configured can be displayed in a pull-down mode, such as the implementation indicated by 501. And then in multiple data acquisition tasks, the required data acquisition task is selected through the second input operation, such as a click operation, so as to realize the selection of the data acquisition task included in the task table.

Alternatively, in addition to the implementation of drop-down selection, for example, an input box can be set on the interface. For example, the user can input an identification of the data acquisition task that needs to be performed in the input box, so that the cloud can determine at least one data acquisition task that included in the task table.

S304, obtaining attribute information of the task table.

Furthermore, in this embodiment, when creating a task table, the attribute information of the task table can be obtained, where the attribute information of the task table includes at least one of the following: vehicle information corresponding to the task table, execution time corresponding to the task table, and a weight value corresponding to each of the at least one data acquisition task in the task table, where the weight value is used to indicate an upload or storage priority for acquired data corresponding to each of the data acquisition tasks.

For example, refer to FIG. 5, where the vehicle information can include, for example, vehicle brands, car series, models and versions. As shown in 502 in FIG. 5, specific vehicle information can be set in task table attributes to indicate which vehicles that the current task list will be sent to for execution.

Furthermore, refer to 503 in FIG. 5, a respective weight value can be set for each of the data acquisition task. In this embodiment, the weight value is used to indicate the upload or storage priority for the acquired data corresponding to each of the data acquisition tasks. In a possible implementation, the larger the weight value, the higher the upload priority of the acquired data, and the higher the storage priority of the acquired data.

Furthermore, refer to 503 in FIG. 5, the execution time of the task table can be set for the task table. For example, as shown in FIG. 5, the data acquisition task will be executed on Nov. 20, 2018. The execution time corresponding to the specific task table can be selected according to the actual requirements, which is not specifically limited in this embodiment.

Furthermore, in addition to the content described above, the attribute information of the task table can also include any content related to the task table. The specific implementation of the attribute information of the task table is not specifically limited in this embodiment, which can be selected according to the actual requirements.

S305, constructing and obtaining a task table according to the attribute information of the task table and the at least one data acquisition task.

After the attribute information of the task table and the at least one data acquisition task have been determined, the task table can be constructed based on the attribute information of the task table and the at least one data acquisition task.

In a possible implementation, the composition of the task table can be seen in Table 1 below, for example:

TABLE 1
Task table

| | |
|---|---|
| ID: | Software version of the vehicle terminal + |
| | data and time composition |
| Attribute: | Brand-vehicle series-model-vehicle terminal version |
| Composition: | At least one data acquisition task |
| State: | Created/tested/failed/released/obsoleted |

Where the identity document (Identity document, ID) of the task table is used to uniquely identify the task table. In a possible implementation, the ID of the task table can be the software version of the vehicle terminal+date and time composition.

Alternatively, in other possible implementations, the ID of the task table can also be numbers, letters, a combination of numbers and letters and so forth. The specific implementation of the ID of the task table is not limited in this embodiment, which can be selected based on the actual requirements.

The following is an exemplary description of the implementation process for constructing a task table based on attribute information and data acquisition tasks in this embodiment:

task table creating: selecting issued vehicle brand, vehicle series, model and software version, and specifying a vehicle terminal to execute the task;

task selecting: selecting task items that need to be executed by qualified vehicles, where the task items creates configurations in advance for selection and use when the task table is created;

weight setting: configuring corresponding weight for each task to determine the priority of storage and transmission sequence after the data acquisition is completed;

task period setting: setting a date range for executing the task, and the vehicle will perform the data acquisition in corresponding scene during the period. The task will automatically be invalidated after an end date is reached.

S306, sending the task table to a target vehicle that matches vehicle information according to the vehicle information corresponding to the task table, where the task table is used to indicate a vehicle to perform the data acquisition during a driving process of the vehicle.

In this embodiment, the attribute information of the task table includes the corresponding vehicle information. Therefore, different task tables require to be executed by different vehicles. The vehicle information can include, for example, the vehicle brand, vehicle series, model and software version, thus the vehicle terminal for executing the task is determined according to the vehicle information. Therefore, in this embodiment, the cloud can send the task table to the target vehicle that matches the vehicle information.

Based on Table 1 above, it can be determined that the task table can have multiple states. In a possible implementation, the task table can be released after the creating for the task table is completed, and the task table can be in a released state after the release is completed. After a full amount release, the task will be issued to all vehicles with the model to which the task belongs, and some vehicles with particular model can also be released in small batches through a vehicle identification number (Vehicle Identification Number, VIN) of the vehicle. VIN information can be inputted manually or uploaded in batches using designated files.

Where the designated file can be, for example, a file in xml format, or it can also be a file in any format, as long as the VIN information can be indicated, which is not specifically limited in this embodiment.

And in another possible implementation, the task table with the status of “released” can also be invalidated manually within a running time range that be set. After the task table is invalidated, the vehicle terminal that has received the task table will stop the data acquisition until it receives other new tasks.

S307, receiving at least one piece of acquired data sent by the vehicle terminal.

After the task list is issued to the designated vehicle terminal, the vehicle terminal can perform the data acquisition for driving scene data during the driving process of the vehicle. In a possible implementation, the vehicle terminal can acquire the designated data content during an acquisition duration in accordance with indications of the data acquisition task, when it is determined that a trigger condition is met, and send at least one piece of the acquired data to the cloud according to the upload times and upload frequency indicated in the data acquisition task.

S308, classifying and storing at least one piece of the acquired data according to tag information corresponding to each of the acquired data.

After the cloud receives at least one piece of the acquired data sent by the vehicle terminal, in which each of the acquired data corresponds to the tag information respectively, and then the cloud can classify and store each of the acquired data according to the tag information. Where the acquired data corresponding to one piece of the tag information can be, for example, stored together, and then a querying can be executed according to the tag information when performs a data query, so that a certain type of data can be determined quickly and efficiently.

The data acquisition method provided in the embodiment of the present disclosure includes: determining the configuration information in response to the first input operation acting on the interface, where the configuration information includes the data acquisition parameters; creating the data acquisition task in response to the task creation instructions, where the configuration information in the current interface is the data included in the data acquisition task; selecting the at least one data acquisition task in response to the second input operation acting on the interface; obtaining the attribute information of the task table; constructing and obtaining the task table according to the attribute information of the task table and the at least one data acquisition task; sending the task table to the target vehicle that matches the vehicle information according to the vehicle information corresponding to the task table, where the task table is used to indicate the vehicle terminal to perform the data acquisition during the driving process of the vehicle; receiving at least one piece of the acquired data sent by the vehicle terminal; and classifying and storing the at least one piece of the acquired data according to the tag information corresponding to each of the acquired data. Data acquisition requirements required by a flexible configuration of the user can be met by determining the configuration information according to the input operation of the user, and then obtaining the data acquisition task according to the configuration information, and a selection for a specific task that requires to be performed can be quickly and flexibly realized by selecting at least one data acquisition task, which improves an operational efficiency. And efficiency and comprehensiveness of the data acquisition can be ensured, and an efficiency and accuracy of the data acquisition can be improved by sending the configured task table to the vehicle terminal that meets the requirements of the task table to enable the vehicle terminal to perform the data acquisition in the actual operation process.

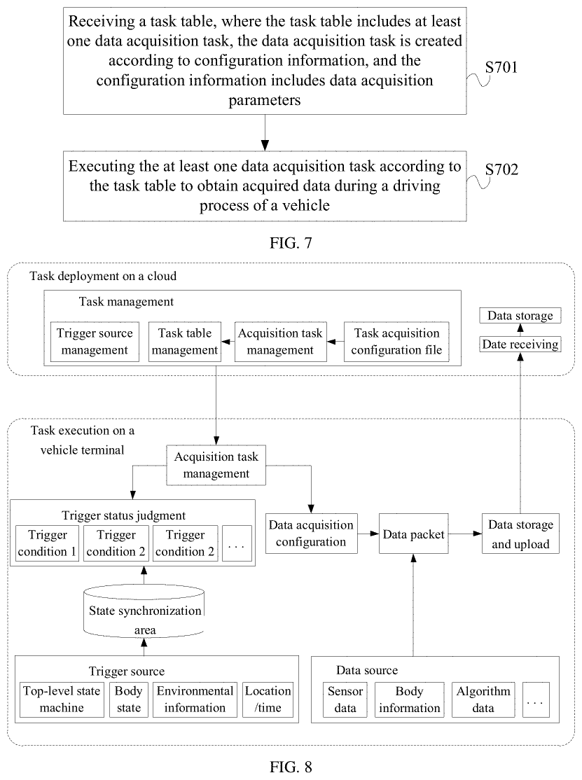

On the basis of the foregoing embodiment, an implementation of the vehicle terminal is introduced below. FIG. 7 is a third flowchart of the data acquisition method provided by the embodiment of the present disclosure.

As shown in FIG. 7, the method includes:

S701, receiving a task table, where the task table includes at least one data acquisition task, the data acquisition task is created according to configuration information, and the configuration information includes data acquisition parameters.

Where the specific implementation of the task table and the configuration information is the same as that described above, and will not be elaborated herein. In this embodiment, a vehicle terminal can receive the task table from a cloud. It is understandable that vehicle information of the vehicle terminal matches the vehicle information in the task table currently received.

In a possible implementation, the cloud can issue the task table through a telematics BOX (Telematics BOX, T-box) and a gateway, and the vehicle terminal checks the task table ID when establishing a connection upwards at a high frequency, in order to maintain a version of the local task table is synchronized with the cloud, and continuously perform acquisition tasks of corresponding items within the period of the task table.

S702, executing at least one data acquisition task according to the task table to obtain acquired data during a driving process of a vehicle.

The task table includes at least one data acquisition task, then the vehicle terminal can execute the data acquisition task. When a vehicle state satisfies a trigger condition of the data acquisition, at least one data content is acquired within the acquisition duration to obtain the acquired data.

After that, the vehicle terminal can send at least one piece of data to the cloud according to the task table, upload times of each data content, upload frequency of each data content, and respective weight value of at least one data acquisition task, where each data carries their respective tag information.

In a possible implementation, the vehicle terminal polls whether it meets the trigger conditions of a cloud configuration according to state information which has trigger sources that continuously synchronized, such as a top-level state machine, a body state, environmental information, and location/time information. When a combination form of the respective trigger source is consistent with the task configuration, the data acquisition is automatically triggered.

After the trigger condition is reached, the vehicle terminal can pull the data of corresponding duration from a memory loop according to the configured acquisition duration, acquired data items, and the frequency and times corresponding to each item. Where the memory cycle is used for erasing and overwriting data cyclic at a predetermined duration while the vehicle is running, and the configured acquisition duration before and after the trigger is required to be less than a total time of the memory cycle, so that the data before the trigger can be recorded by backtracking several seconds at a trigger point.

The acquired data can be automatically matched with tags preset in the cloud according to triggering rules, and can be recorded and transmitted along with a data format. During this period, a sequence mechanism for real-time uploading or caching is determined according to network conditions and the weight of the assigned task, where the cached data is also overwritten and uploaded according to the task weight and the sequence.

The cloud will perform classification and storage operations according to the steps after receiving the data uploaded by the vehicle terminal, for a usage of subsequent data requirements such as training, testing, and diagnosis.

The data acquisition method provided by the embodiment of the present disclosure includes: receiving a task table, where the task table includes at least one data acquisition task, the data acquisition task is created based on configuration information, and the configuration information includes data acquisition parameters; and executing at least one the data acquisition task through the task table to obtain acquired data during a driving process of the vehicle. An efficiency and comprehensiveness of the acquired data can be ensured effectively by performing the data acquisition during the driving process of the vehicle according to the task table of the vehicle terminal, and pertinence and flexibility of the data acquisition can be ensured by the task table including at least one the data acquisition task configured according to actual requirements.

On the basis of the foregoing embodiment, a collaborative work process of the vehicle terminal and the cloud in the data acquisition method provided by the embodiment of the present disclosure will be described in combination with FIG. 8. FIG. 8 is a schematic flow diagram of the data acquisition method provided by the embodiment of the present disclosure.

As shown in FIG. 8, a system can include two parts: cloud task deployment and vehicle terminal task execution, and work is carried out in the cloud and the vehicle terminal, respectively.

Where after data requirements are generated, a user can configure a data acquisition task on an operational interface of the cloud. Among them, a task acquisition configuration file can be determined, a trigger source can be managed to indicate respective configuration information of the data acquisition task, and the acquisition tasks can also be managed and at least one data acquisition task can be selected, so that to manage the task table to obtain the task table issued to the vehicle terminal.

Where the users can flexibly configure the data acquisition tasks in the cloud according to actual data requirements. Compared with a large number of professional scene configurations in advance that required in an acquisition vehicle, the method configured through the operation interface in the cloud in this embodiment can effectively improve the flexibility and efficiency of the task configuration and reduce an operation difficulty.

After the task table is constructed, the cloud can send the task table to a designated vehicle.

After that, the vehicle terminal will perform the data acquisition according to the data acquisition tasks included in the task table. Where the vehicle can determine whether a trigger source triggers acquisition conditions in a state synchronization area according to the trigger conditions and vehicle status in the task table, where the trigger source may include, for example, the top-level state machine, the vehicle body state, the environmental information, position/time and so forth as shown in FIG. 8, and then the trigger condition is the condition corresponding to these trigger sources. The specific implementation of the trigger source and trigger condition is not limited in this embodiment, which can be selected according to the actual requirements.

The vehicle performs the data acquisition according to relevant configuration information of the data acquisition to obtain a data source when it is determined that the vehicle state triggers acquisition conditions, where the relevant configuration information of the data acquisition may include, for example, data format, data acquisition frequency and so forth, and the data source constituted by the acquired data may include, for example, sensor data, vehicle body information, algorithm data and so forth. The specific content of the acquired data is not particularly limited in this embodiment, which can be selected and set according to actual data acquisition requirements.

After the data acquisition is completed and the data source is obtained, the vehicle terminal can package the data separately, and a data packet with larger weights will be priority uploaded to a server according to respective weights of each data acquisition task, where the vehicle can, for example, upload the data to the server through the gateway (Gateway) and the Telematics BOX (TelematicsBOX, T-box).

For the server that cannot be uploaded in real time, it can also be saved on the vehicle terminal according to the weight, and then uploaded to the server when the network conditions getting better.

The server will store the data after receiving the data acquired by the vehicle terminal according to the instruction information, and classify and store the data according to tag information of the data, the implementation of which can refer to the above-mentioned embodiment, which will not be elaborate herein.

Moreover, the server can also manage the data. For example, after the cloud receives the data uploaded by the vehicle terminal, it can perform classification and storage operations step by step for a usage of subsequent data requirements such as training, testing, and diagnosis.

The above process shows a design for implementing a high-efficiency data acquisition process through a mechanism that tasks on the cloud are autonomous configured and the tasks on the vehicle terminal are autonomous acquired according to the requirements of research and development for driving data acquisition of target scenes. This method can be implemented in internal vehicles of an enterprise, and can also be implemented in the post-production user vehicles with sensors related to autonomous driving. It is especially suitable for a mode of cooperation for extensive data acquisition.

In summary, the data acquisition method provided by the embodiment of the present disclosure meets data requirements required by research and development personnel for flexibly configuring models through a mechanism that deploying and issuing tasks on the cloud, and automatically triggering the acquisition and uploading according to the task items on the vehicle terminal. Through a task configuration in a form that combining the collection items, various types of scene data acquisition tasks can be described and created flexibly, diversely and conveniently. At the same time, with help of mass-manufactured vehicles of the user running on real roads across the country and even around the world, data required by target scene can be acquired in a short time, on a large scale and at low cost, which would greatly increases data input-output of autonomous driving research and development institutions.

The present disclosure provides a data acquisition method and apparatus, which are applied in the field of autonomous driving in computer technology, in order to achieve the technical effect of improving a comprehensiveness and efficiency of the data acquisition.

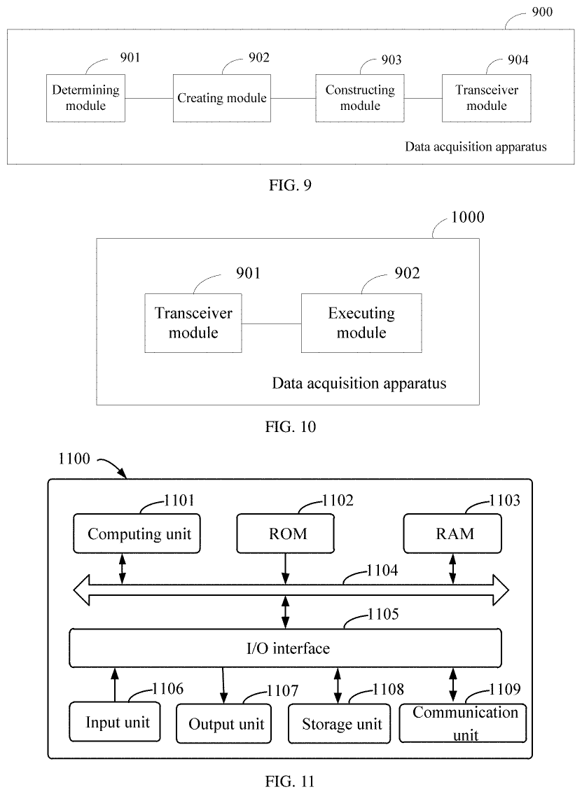

FIG. 9 is a schematic structural diagram of a data acquisition apparatus according to an embodiment of the present disclosure, which is applied to a cloud. As shown in FIG. 9, the data acquisition apparatus 900 of this embodiment may include: a determining module 901, a creating module 902, a constructing module 903 and a transceiver module 904.

The determining module 901 is configured to determine configuration information in response to a first input operation acting on an interface, where the configuration information includes data acquisition parameters;

the creating module 902 is configured to create a data acquisition task in response to task creation instructions, where the configuration information in a current interface is data included in the data acquisition task;

the constructing module 903 is configured to construct and obtain a task table according to at least one of the data acquisition tasks; and

the transceiver module 904 is configured to send the task table to a vehicle terminal, where the task table is used to instruct the vehicle terminal to perform the data acquisition during a driving process of a vehicle.

In a possible implementation, the constructing module 903 includes:

a selecting unit, configured to select at least one the data acquisition task in response to a second input operation acting on the interface;

an obtaining unit, configured to obtain attribute information of the task table; and

a constructing unit, configured to construct and obtain the task table according to the attribute information of the task table and at least one of the data acquisition tasks.

In a possible implementation, the attribute information of the task table includes at least one of the following: vehicle information corresponding to the task table, execution time corresponding to the task table, and a weight value corresponding to each of the at least one of the data acquisition tasks in the task table, where the weight value is used to indicate an upload or storage priority of acquired data corresponding to each of the data acquisition tasks.

In a possible implementation, the transceiver module 904 includes:

a sending unit, configured to send the task table to a target vehicle that matches vehicle information according to the vehicle information corresponding to the task table.

In a possible implementation, the configuration information includes at least one of the following: a trigger condition for the data acquisition, an acquisition duration, at least one piece of acquired data content, data upload times of each data content, data upload frequency of the each data content and tag information.

In a possible implementation, the transceiver module 904 further includes:

a receiving unit, configured to receive at least one piece of acquired data sent by the vehicle terminal; and

a storage unit, configured to classify and store the at least one piece of acquired data according to the tag information corresponding to each of the acquired data.

FIG. 10 is a schematic structural diagram of a data acquisition apparatus according to another embodiment of the present disclosure, which is applied to a vehicle terminal. As shown in FIG. 10, the data acquisition apparatus 1000 of this embodiment may include: a transceiver module 1001 and an executing module 1002.

The transceiver module 1001 is configured to receive a task table, where the task table includes at least one data acquisition task, the data acquisition task is created according to configuration information, and the configuration information includes data acquisition parameters; and

the executing module 1002 is configured to execute the at least one data acquisition task according to the task table to obtain acquired data during a driving process of a vehicle.

In a possible implementation, the configuration information includes at least one of the following: a trigger condition for the data acquisition, an acquisition duration, at least one piece of acquired data content, data upload times of each data content, data upload frequency of the each data content and tag information.

In a possible implementation, the executing module 1002 includes:

an executing unit, configured to acquire the at least one piece of data content within an acquisition period according to the task table, when a vehicle state satisfies trigger conditions of the data acquisition.

In a possible implementation, the attribute information of the task table includes at least one of the following: vehicle information corresponding to the task table, execution time corresponding to the task table, and a weight value corresponding to each of the at least one of the data acquisition tasks in the task table, where the weight value is used to indicate an upload or storage priority of acquired data corresponding to the each of data acquisition tasks.

In a possible implementation, the transceiver module 1001 further includes:

a sending unit, configured to send at least one piece of data to the cloud according to the task table, in accordance with the upload times of each of the data content, upload frequency of each of the data content, and the weight value corresponding to each of the at least one data acquisition task, where each of the data carries its own tag information.

According to the embodiments of the present disclosure, the present disclosure also provides an electronic device and a readable storage medium.

According to an embodiment of the present disclosure, the present disclosure also provides a computer program product, where the program product includes: computer programs, the computer program is stored in a readable storage medium, at least one processor of the electronic device can read the computer program from the readable storage medium, and the at least one processor executes the computer program to enable the electronic device to execute the solution provided in any of the foregoing embodiments.

FIG. 11 shows a schematic block diagram of an example electronic device 1100 that can be used to implement embodiments of the present disclosure. The electronic device is intended to represent various forms of digital computers, such as laptop computers, desktop computers, workstations, personal digital assistants, servers, blade servers, mainframe computers and other suitable computers. The electronic device can also represent various forms of mobile apparatuses, such as personal digital assistant, cellular phones, smart phones, wearable devices and other similar computing apparatuses. Components, their connections and relationships and their functions shown herein are merely examples, and are not intended to limit the implementation of the present disclosure described and/or required herein.

As shown in FIG. 11, the electronic device 1100 includes a computing unit 1101, which can execute various appropriate actions and processing based on computer programs stored in a read only memory (ROM) 1102 or the computer program that loaded from a storage unit 1108 to a random access memory (RAM) 1103. In the RAM 1103, various programs and data required for an operation of the electronic device 1100 can also be stored. The calculation unit 1101, the ROM 1102 and the RAM 1103 are connected to each other through a bus 1104. And an input/output (I/O) interface 1105 is also connected to the bus 1104.

Multiple components in the electronic device 1100 are connected to the I/O interface 1105, which includes: an input unit 1106, such as keyboards and mouse; an output unit 1107, such as various types of displays, and speakers; a storage unit 1108, such as disks, and optical disc; and a communication unit 1109, such as network cards, modems, and wireless communication transceivers. The communication unit 1109 allows the electronic device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include, but are not limited to, central processing unit (CPU), graphics processing unit (GPU), various dedicated artificial intelligence (AI) computing chips, various computing units that run machine learning model algorithms and digital signal processors (DSP), as well as any appropriate processor, controller, microcontroller and so forth. The calculation unit 1101 executes the various methods and processes described above, such as the data acquisition method. For example, in some embodiments, the data acquisition method can be implemented as a computer software program, which is tangibly contained in a machine-readable medium, such as the storage unit 1108. In some embodiments, part or all of the computer program may be loaded and/or installed on the electronic device 1100 via the ROM 1102 and/or the communication unit 1109. The computer program can execute one or more steps of the data acquisition method described above when loaded into the RAM 1103 and executed by the computing unit 1101. Alternatively, in other embodiments, the computing unit 1101 may be configured to perform the data acquisition method in any other suitable manner (for example, by means of firmware).

According to an embodiment of the present disclosure, the present disclosure also provides a computer program product, including computer programs, and the computer program implements the various methods and processing described above, such as data acquisition method, when executed by a processor.

Various implementations of the systems and technologies described above herein can be implemented in digital electronic circuit systems, integrated circuit systems, field programmable gate arrays (FPGA), application-specific integrated circuits (ASIC), application-specific standard products (ASSP), system on chip (SOC), load programmable logic device (CPLD), computer hardware, firmware, software, and/or a combination thereof. The various implementations may include: being implemented in one or more computer programs, where the one or more computer programs may be executed and/or interpreted on a programmable system including at least one programmable processor, the programmable processor can be a dedicated or general-purpose programmable processor that can receive data and instructions from a storage system, at least one input apparatus and at least one output apparatus, and transmit the data and instructions to the storage system, the at least one input apparatus and the at least one output apparatus.

Program codes used to implement the method of the present disclosure can be written in any combination of one or more programming languages. These program codes can be provided to the processors or controllers of the general-purpose computers, special-purpose computers or other programmable data processing apparatus, so that functions/operations specified in the flowcharts and/or block diagrams can be implemented when the program codes are executed by the processors or controllers. The program code can be entirely executed on a machine, partly executed on the machine, partly executed on the machine and partly executed on a remote machine as an independent software package, or entirely executed on the remote machine or a server.

In the context of the present disclosure, the machine-readable medium may be a tangible medium, which may contain or store a program for use by an instruction execution system, apparatus, or device or in combination with the instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus or devices, or any suitable combination of the foregoing. More specific examples of the machine-readable storage media would include electrical connections based on one or more wires, portable computer disks, hard disks, random access memories (RAM), read-only memories (ROM), erasable programmable read-only memories (EPROM or flash memory), optical fibers, portable compact disk read-only memories (CD-ROM), optical storage devices, magnetic storage devices, or any suitable combination of the foregoing.

In order to provide an interaction with the user, the system and technologies described herein can be implemented on a computer, and the computer includes: a display apparatus for displaying information to the user (for example, CRT (cathode ray tube) or LCD (liquid crystal display) monitor); and a keyboard and pointing apparatus (for example, a mouse or a trackball) through which the user can provide input to the computer. Other types of apparatuses can also be used to provide the interaction with the user; for example, feedback provided to the user can be any form of sensory feedback (for example, visual feedback, auditory feedback, or tactile feedback); and the input from the user can be received in any form (including acoustic input, voice input, or tactile input).

The systems and technologies described herein can be implemented in a computing system that includes back-end components (for example, a data server), or a computing system that includes middleware components (for example, an application server), or the computing system that includes front-end components (for example, a user computer with a graphical user interface or a web browser, through which the user can interact with the implementation of the system and technology described herein), or the computing system that includes any combination of such back-end components, middleware components, or front-end components. The components of the system can be connected to each other through a digital data communication (for example, a communication network) in any form or medium. Examples of the communication networks include: local area network (LAN), wide area network (WAN), and the Internet.

The computer system may include a client and a server. The client and the server are generally far away from each other and usually interact through a communication network. A relationship between the client and the server is generated by running the computer programs have a client-server relationship with each other on the corresponding computers. The server can be a cloud server, also known as a cloud computing server or a cloud host, which is a host product in the cloud computing service system to solve shortcomings of difficult management and weak business scalability among a traditional physical host and a VPS service (“Virtual Private Server”, or “VPS” for short). The server can also be a server of a distributed system, or a server combined with a blockchain.

It should be understood that the various forms of processes shown above can be used to reorder, add or delete steps. For example, the steps described in the present disclosure can be executed in parallel, sequentially, or in a different order, as long as a desired result of the technical solution disclosed in the present disclosure can be achieved, which is not limited herein.

The above specific implementations do not constitute a limitation on a protection scope of the present disclosure. Those skilled in the art should understand that various modifications, combinations, sub-combinations and substitutions can be made according to design requirements and other factors. Any modification, equivalent replacement and improvement made within a spirit and principle of the present disclosure shall be included in the protection scope of the present disclosure.

What is claimed is:

1. A data acquisition method, applied to a cloud, comprising:
determining configuration information in response to a first input operation acting on an interface, wherein the configuration information comprises data acquisition parameters;
creating a data acquisition task in response to task creation instructions, wherein the configuration information in a current interface is data comprised in the data acquisition task;
constructing and obtaining a task table according to at least one of the data acquisition tasks; and
sending the task table to a vehicle terminal, wherein the task table is used to indicate the vehicle terminal to perform data acquisition during a driving process of a vehicle.

2. The method according to claim 1, wherein the constructing and obtaining a task table according to at least one of the data acquisition tasks comprises:
selecting at least one data acquisition task in response to a second input operation acting on the interface;
obtaining attribute information of the task table; and
constructing and obtaining the task table according to the attribute information of the task table and the at least one data acquisition task.

3. The method according to claim 1, wherein the attribute information of the task table comprises at least one of the following: vehicle information corresponding to the task table, execution time corresponding to the task table, and a weight value corresponding to each of the at least one of the data acquisition tasks in the task table, wherein the weight value is used to indicate an upload or storage priority of acquired data corresponding to each of the data acquisition tasks.

4. The method according to claim 1, wherein the sending the task table to a vehicle terminal comprises:
sending the task table to a target vehicle that matches vehicle information according to the vehicle information corresponding to the task table.

5. The method according to claim 1, wherein the configuration information comprises at least one of the following: a trigger condition of the data acquisition, an acquisition duration, at least one piece of acquired data content, data upload times of each of the data content, data upload frequency of each of the data content and tag information.

6. The method according to claim 5, further comprising:
receiving at least one piece of acquired data sent by the vehicle terminal; and
classifying and storing the at least one piece of acquired data according to the tag information corresponding to each of the acquired data.

7. A data acquisition method, applied to a vehicle terminal, wherein the method comprises:
receiving a task table, wherein the task table comprises at least one data acquisition task, the data acquisition task is created according to configuration information, and the configuration information comprises data acquisition parameters; and
executing the at least one data acquisition task according to the task table to obtain acquired data during a driving process of a vehicle.

8. The method according to claim 7, wherein the configuration information comprises at least one of the following: a trigger condition of data acquisition, an acquisition duration, at least one piece of acquired data content, data upload times of each of the data content, data upload frequency of each of the data content and tag information.

9. The method according to claim 8, wherein the executing the at least one data acquisition task according to the task table to obtain acquired data during a driving process of a vehicle comprises:
acquiring the at least one piece of the data content within the acquisition duration according to the task table, when a vehicle state satisfies the trigger condition of the data acquisition.

10. The method according to claim 7, wherein the attribute information of the task table comprises at least one of the following: vehicle information corresponding to the task table, execution time corresponding to the task table, and a weight value corresponding to each of the at least one of the data acquisition tasks in the task table, wherein the weight value is used to indicate an upload or storage priority of acquired data corresponding to each of the data acquisition tasks.

11. The method according to claim 10, further comprising:
sending at least one piece of data to the cloud according to the task table, in accordance with upload times of each of the data content, upload frequency of each of the data content, and the weight value corresponding to each of the at least one data acquisition task, wherein each of the data carries its own tag information.

12. A data acquisition apparatus, applied to a cloud, wherein the device comprises:
at least one processor;
a communication interface connected with the at least one processor; and
a memory connected with the at least one processor; wherein,
the memory stores instructions executable by the at least one processor, and the instructions are executed by the at least one processor to enable the at least one processor to:
determine configuration information in response to a first input operation acting on an interface, wherein the configuration information comprises data acquisition parameters;
create a data acquisition task in response to task creation instructions, wherein the configuration information in a current interface is data comprised in the data acquisition task;
construct and obtain a task table according to at least one of the data acquisition tasks; and
send, through the communication interface, the task table to a vehicle terminal, wherein the task table is used to indicate the vehicle terminal to perform data acquisition during a driving process of a vehicle.

13. The apparatus according to claim 12, wherein the at least one processor is further configured to:
select at least one data acquisition task in response to a second input operation acting on the interface;
obtain attribute information of the task table; and
construct and obtain the task table according to the attribute information of the task table and the at least one data acquisition task.

14. The apparatus according to claim 12, wherein the at least one processor is further configured to:
send, through the communication interface, the task table to a target vehicle that matches vehicle information according to the vehicle information corresponding to the task table.

15. The apparatus according to claim 12, wherein the at least one processor is further configured to:
receive, through the communication interface, at least one piece of acquired data sent by the vehicle terminal; and
classify and store the at least one piece of acquired data according to tag information corresponding to each of the acquired data.

16. A data acquisition apparatus, applied to a vehicle terminal, wherein the apparatus comprises:
at least one processor;
a communication interface connected with the at least one processor; and
a memory connected with the at least one processor; wherein,
the memory stores instructions executable by the at least one processor, and the instructions are executed by the at least one processor to:
receive, through the communication interface, a task table, wherein the task table comprises at least one data acquisition task, the data acquisition task is created according to configuration information, and the configuration information comprises data acquisition parameters; and
execute the at least one data acquisition task according to the task table to obtain acquired data during a driving process of a vehicle.

17. The apparatus according to claim 16, wherein the at least one processor is further configured to:
acquire at least one piece of data content within an acquisition duration according to the task table, when a vehicle state satisfies a trigger condition of data acquisition.

18. The apparatus according to claim 16, wherein the at least one processor is further configured to:
send, through the communication interface, at least one piece of data to the cloud according to the task table, in accordance with upload times of each of the data content, upload frequency of each of the data content, and a weight value corresponding to each of the at least one data acquisition task, wherein each of the data carries its own tag information.

19. A data acquisition system, comprising: a cloud and a vehicle terminal, wherein the cloud is configured to execute the method according to claim 1.

20. A non-transitory computer-readable storage medium storing computer instructions, wherein the computer instructions are used to enable a computer to execute the method according to claim 1.
